(19) United States
(12) Patent Application Publication
(10) Pub. No.: US 2007/0285578 A1
(43) Pub. Date: Dec. 13, 2007

(54) METHOD FOR MOTION DETECTION AND METHOD AND SYSTEM FOR SUPPORTING ANALYSIS OF SOFTWARE ERROR FOR VIDEO SYSTEMS

(76) Inventors: Masaki Hirayama, Kawasaki (JP); Yasuyuki Oki, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/740,304

(22) Filed: Apr. 26, 2007

(30) Foreign Application Priority Data
May 17, 2006 (JP) 2006-137847

(51) Int. Cl. H04N 5/14

(52) U.S. Cl. 348/700; 348/E05.065

(57) ABSTRACT

Method and system for facilitating analysis of causes of abnormalities found during a test on a video system. Video output from the system during the test, operation log of a test worker, and images generated by image analysis unit analyzing characteristic quantities of the video output from the system and determining points of change of the video and moving objects in the video, are recorded in storage device. Relation between the direction of the moving objects in the video and the direction of user input operations is checked and the moving objects in the video are classified into user-manipulation objects and non-manipulation objects and recorded. Abnormality occurrence locations are recorded. Recorded data are searched, classified and displayed by using as a key the abnormality categories, operation patterns of the operation logs, images of abnormality occurrence scenes and images of manipulation objects.

### INCORPORATION BY REFERENCE

The present application claims priority from Japanese application JP 2006-137847 filed on May 17, 2006, the content of which is hereby incorporated by reference into this application.

### BACKGROUND OF THE INVENTION

The present invention relates to a method for motion detection and method and System for supporting Analysis of software error for video systems. More specifically, in a video system capable of manipulating objects in video or image data, the invention relates to a method of detecting a moving object in a video or image suited for use in supporting an analysis of causes of abnormalities or faults that occur when generating video data or objects in video and also to a software error analysis support method and system.

In a video system in which a user of a home video game machine or virtual reality system performs irregular input operations, if an abnormality or fault should occur as a result of some operations, it may be difficult to reproduce the same abnormal condition. There may be a variety of causes for the error, including an input operation timing or an internal state of the system. Among conventional technologies to solve this problem, a technique described in JP-A-10-28776 (patent document 1) is known. This conventional technique records all input operations made by the user or records not only the user's input operations but also video output from the system, thus making it possible to check the content of anomalies and the operations performed.

Another conventional technique disclosed in JP-A-11-203002 (patent document 2) for example restores the recorded input operations, in addition to recording the input operations performed by the user, to reinstate a system status that existed at any desired point in time or reproduces input operations performed during a test.

### SUMMARY OF THE INVENTION

In the conventional techniques described above, to analyze the cause of an abnormality in the system requires checking the recorded operation logs and viewing videos one by one to collect information about anomaly occurrence locations. This process takes significant time and labor. Particularly, when the system test is performed parallelly by many staffs, the conventional process takes particularly large amounts of time and labor.

Another problem of the conventional techniques is that the videos and operation logs recorded during the video system test can only be analyzed one at a time, making it impossible to check and compare a plurality of similar abnormalities that have occurred at different locations.

To solve the above problems experienced with the conventional techniques, it is an object of this invention to provide a method for detecting moving objects in a video and a method and system for supporting the analysis of causes for abnormalities that have occurred in the video system. In a video system capable of manipulating objects in the video, the method of this invention detects moving objects in the video output from the video system and, based on the information about the detected moving objects, makes it possible to compare videos and operation logs for the locations where the same abnormalities have occurred, thus facilitating the analysis of possible causes of abnormalities.

The above objective of this invention can be achieved by a motion detection method for detecting moving objects in a video output from a video system capable of manipulating objects included in the video. The motion detection method comprises the steps of: detecting a motion of an object included in the video; acquiring a content of input operations on the video system from an input device; and from a relation (correlation) between a direction of motion of the moving object detected by the motion detection step and the content of the input operations on the video system, deciding whether the moving object detected by the motion detection step is moving according to, or irrespective of, the input operations on the video system from the input device.

Further, the above objective can be realized by a motion detection method for detecting moving objects in a video output from a video system capable of manipulating objects included in the video. The motion detection method comprises the steps of: detecting a motion of an object included in the video; acquiring a content of input operations on the video system from an input device; and from a relation (correlation) between a trace of the moving object obtained by connecting, with reference to time, positions of the moving object detected by the motion detection step and an input trace obtained by picking up input operations representing directions from among input operations on the video system from the input device and connecting them with reference to time, deciding whether the moving object detected by the motion detection step is moving according to, or irrespective of, the input operations to the video system from the input device.

Since according to the invention it is possible to determine whether the moving object in the video is moving as a result of manipulation by the user and, for abnormalities found during the test on the video system, can compare videos and operation logs of the locations where the same abnormalities have occurred, the analysis of causes for abnormalities can be performed more easily.

Other objects, features and advantages of the invention will become apparent from the following description of the embodiments of the invention taken in conjunction with the accompanying drawings.

### BRIEF DESCRIPTION OF THE DRAWINGS

FIG. 1 is a block diagram showing a configuration of a video system abnormality cause analysis support system according to one embodiment of this invention.

FIG. 2 is a block diagram showing a configuration of a video system abnormality cause analysis support system according to another embodiment of this invention.

FIG. 3 illustrates data to be recorded in a storage device during a test of the video system.

FIG. 4 is a flow chart showing an example sequence of operations executed by a manipulation object detection unit in detecting an object being manipulated.

FIG. 5 is a flow chart showing another sequence of operations executed by the manipulation object detection unit in detecting an object being manipulated.

FIG. 6 is a flow chart showing a detailed sequence of operations executed by step 305 of FIG. 5 in determining a level of similarity between a trace of a moving object and a trace of an operation direction.

FIG. 7 shows an example of a search result acquired by a search unit after having searched through data recorded in the storage device during a test.

FIG. 8 shows example screens representing the search result shown in FIG. 7(b).

FIG. 9 is a block diagram showing a configuration of a video system abnormality cause analysis support system according to still another embodiment of this invention.

### DESCRIPTION OF THE EMBODIMENTS

Now, the method of detecting a moving object in a video and the video system abnormality cause analysis support method and system according to this invention will be described in detail by referring to the accompanying drawings of example embodiments.

The embodiments of this invention that are described in the following are intended to facilitate an analysis of causes for abnormalities that are found during a test of a video system capable of manipulating an object in a video. Thus, the embodiments of this invention have an image analysis processing unit and a manipulation object detection processing unit connected to a video system to record videos, operation logs and images of the manipulation object during the test and to search the recorded data to display only desired data on the monitor.

During the test of the video system, the embodiments of this invention not only record the output video from the video system and the user operation logs but also record abnormalities, detect moving objects and points of video change in the output video from the video system by an image analysis processing and, based on the correspondence between a direction in which the moving object in the output video from the video system moves and a direction of user operation, classify the moving objects as those manipulated by the user and those not manipulated by the user before recording them. Various kinds of recorded data are displayed, classified according to the content of anomaly. Further, from among the results of classification of abnormalities, only those data are displayed whose scenes or objects at the time of occurrence of abnormality match. This allows a person analyzing the cause of anomaly to easily identify factors or elements commonly present in, or differing between, the scenes where similar abnormalities occur.

The abnormality cause analysis support system according to an embodiment of this invention is built in an information processing device, typically a personal computer, which includes a CPU, a main memory and a HDD. Function units making up the abnormality cause analysis support system are constructed as programs stored in the HDD. These programs, when loaded in the main memory and executed by the CPU under the control of an operating system, realize the functions of the abnormality cause analysis support system.

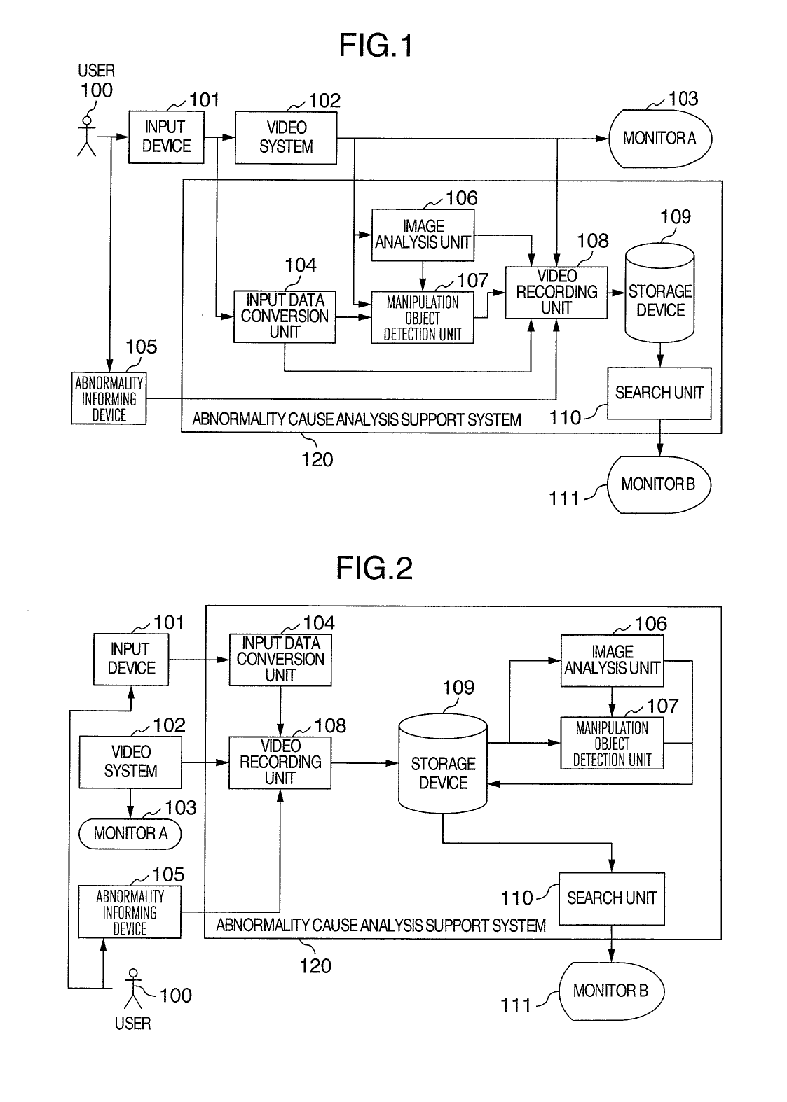

FIG. 1 is a block diagram showing a configuration of the abnormality cause analysis support system as one embodiment of this invention. This embodiment acquires data during the test on a video system and displays the data. In FIG. 1, denoted 100 is a user, 101 an input device, 102 a video system, 103 a monitor A, 104 an input data conversion unit, 105 an abnormality informing device, 106 an image analysis unit, 107 a manipulation object detection unit, 108 a video recording unit, 109 a storage device, 110 a search unit, 111 a monitor B, and 120 the abnormality cause analysis support system.

The user 100 is a person who performs a test by operating the video system 102 through the input device 101. The input device 101 is one generally used in a game machine and may be a device that executes an input operation by pressing buttons, or a device that uses a voice recognition technology to perform the input operation, or a device that takes in a state of a sensor, such as optical sensor and gyro, for input operation. An output video from the video system 102 is displayed on the monitor A 103. The abnormality informing device 105, when the user 100 recognizes an abnormal condition of the video system 102, inputs the content of the abnormality that occurred in the video system 102 and transfers it to the video recording unit 108 for recording in the storage device 109.

The abnormality cause analysis support system 120 comprises the input data conversion unit 104, the image analysis unit 106, the manipulation object detection unit 107, the video recording unit 108, the storage device 109 and the search unit 110. During the test on the video system 102 various data are collected by the input data conversion unit 104, image analysis unit 106, manipulation object detection unit 107 and video recording unit 108 and then recorded in the storage device 109. The search unit 110 reads the recorded data from the storage device 109 and displays it on the monitor B 111 to support the abnormality cause analysis.

A signal from the input device 101 is distributed to the input data conversion unit 104 before arriving at the video system 102. This input signal is converted into a format that allows for analysis and recording and then sent to the manipulation object detection unit 107 and the video recording unit 108. A video output from the video system 102 is distributed to the abnormality cause analysis support system 120 before arriving at the monitor A 103. The video signal from the video system 102 may be converted by an analog-digital converter before entering the abnormality cause analysis support system 120. The abnormality cause analysis support system 120 sends the video signal to the image analysis unit 106, the manipulation object detection unit 107 and the video recording unit 108.

The image analysis unit 106 calculates a feature quantity of the output video of the video system 102, detects images of points of video change and moving objects in the video, performs the image analysis such as detection of the direction of motion of the moving object, and then sends the result to the video recording unit 108. The manipulation object detection unit 107 checks the input data from the input data conversion unit 104, the result of detection of the moving object by the image analysis unit 106 and the direction of movement, determines whether the moving object is an object being manipulated by the user 100 or a non-manipulation object, and then sends the decision result to the video recording unit 108. The process of detecting a moving object from the video output from the video system 102 may be executed by the manipulation object detection unit 107. The video recording unit 108 records in the storage device 109 the output video from the video system 102, the input data conversion result from the input data conversion unit 104, the content of abnormality detected by the abnormality informing device 105, the result from the image analysis unit 106 and the detection result from the manipulation object detection unit 107, by using time and user ID as a key.

With the above processing executed, the data obtained during the test on the video system 102 is recorded in the storage device 109.

From the data recorded in the storage device 109 during the test, only the desired data is retrieved through the search unit 110 by using the anomaly category, the abnormality occurrence scene, the manipulation object and the non-manipulation object as a key. The retrieved data is output to the monitor B 111. This search is executed independently of the test according to an instruction by an analyzing person using an input device not shown, such as a keyboard or a mouse.

The storage device 109 and the search unit 110 may be built in another information processing device such as personal computer to store an output from the video recording unit 108 in a storage device of the second information processing device, which then executes the search.

In the above search operation, although the abnormality occurrence scene and the manipulation object are image data, the use of the image similarity check technique, one of the image analysis techniques, makes it possible to search images in a way similar to that when sentences are searched. By searching anomaly category data of interest and displaying all search results on the monitor B 111, factors or elements commonly involved in the anomaly category of interest can be made easy to detect, facilitating the analysis of causes of the abnormality. Further, from the result of search for the data of a particular anomaly category, another search may be made by specifying the abnormality occurrence scene and the manipulation object at time of abnormality occurrence to narrow down the data of the test for further analysis.

FIG. 2 is a block diagram showing a configuration of the video system abnormality cause analysis support system as another embodiment of this invention. The same reference numbers as those of FIG. 1 are used.

This embodiment shown in FIG. 2 is similar to the embodiment of FIG. 1, except that the image analysis unit 106 and the manipulation object detection unit 107 retrieve the recorded video from the storage device 109 for processing.

In the example shown in FIG. 1, the video output from the video system 102 is supplied to the image analysis unit 106 and the manipulation object detection unit 107. If the output video of the video system 102 is an ordinary TV video, it is sent at a rate of 50-60 frames per second. So, if the processing loads of the image analysis unit 106 and the manipulation object detection unit 107 are large, the video at the rate of 50-60 frames per second may not be able to be processed.

To deal with this problem, in the second embodiment shown in FIG. 2, the data from the input data conversion unit 104, the video system 102 and the abnormality informing device 105 are first stored in the storage device 109 through the video recording unit 108. Then, the image analysis unit 106 and the manipulation object detection unit 107 retrieve the video from the storage device 109 for processing and then record the processed result in the storage device 109. In the example shown in FIG. 2, since the processing by the image analysis unit 106 and the manipulation object detection unit 107 is executed based on the recorded video, if the load to be processed is heavy, all image data can be processed by taking a longer time than the actual time length of the video.

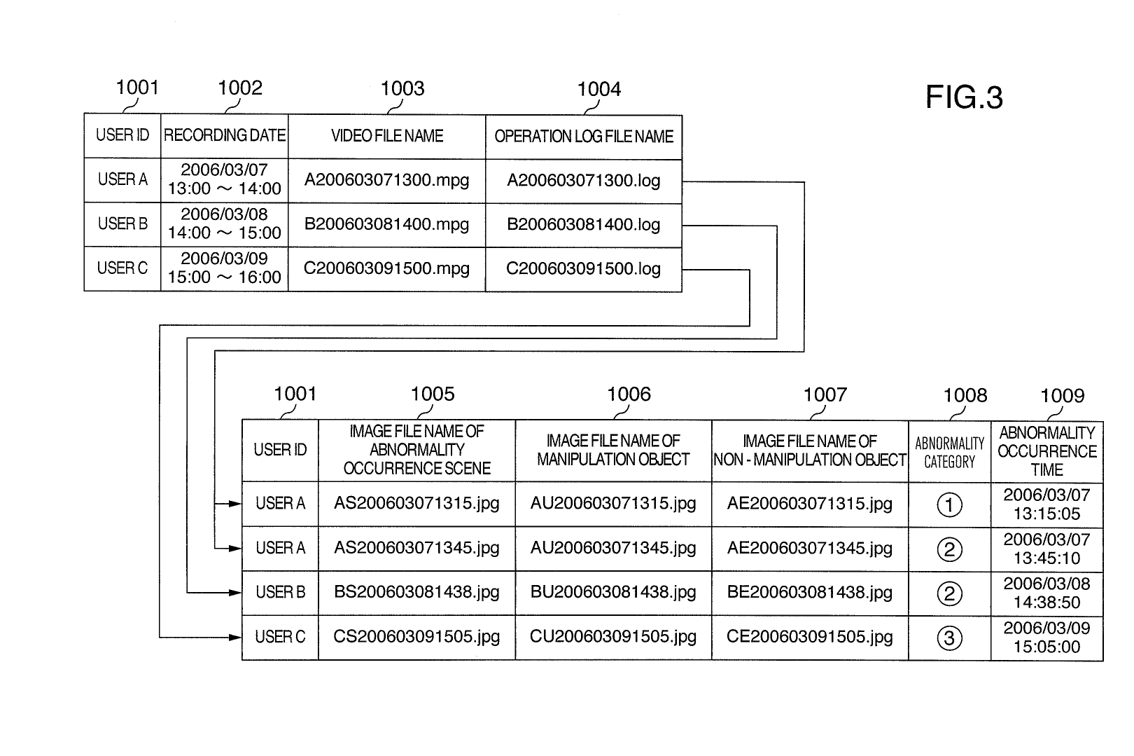

FIG. 3 shows data obtained from a test on the video system 102 and recorded in the storage device 109.

As shown in FIG. 3, the test data comprises four pieces of basic data, namely, a user ID 1001, a recording date and time 1002, a video file name 1003 and an operation log file name 1004. To these basic data are added associated data which includes an image file name 1005 of an abnormality occurrence scene, a manipulation object image file name 1006, a non-manipulation object image file name 1007, an anomaly category 1008 and an abnormality occurrence time 1009. These basic data and associated data are stored in combination. There may be two or more pieces of the associated data for the basic data. For example, in the case of FIG. 3, for the basic data with the user ID of user A, two pieces of associated data with the user ID of user A are recorded. The two pieces of associated data may be distinguished by the abnormality occurrence time 1009.

The user ID 1001 is recorded with information that identifies the user who performed the test on the video system 102. The recording date and time 1002 is recorded with date and time when the test of the video system 102 was conducted. The video file name 1003 is recorded with a file name of the video file showing the test of the video system 102. When a footage of the video system 102 being tested is recorded in a tape or DVD, an identity number of the tape or DVD may be recorded instead of the video file name. The operation log file name 1004 is recorded with a file name of the file that contains input operations the user 100 performed through the input device 101 during the test of the video system 102. If the input operations are recorded in a tape or DVD, an identity number for the tape or DVD may be recorded instead of the operation log file name.

The image file name 1005 of an abnormality occurrence scene is recorded with points of video change detected by the image analysis unit 106. Recording a point of change immediately before the anomaly occurs can identify a scene in which the abnormality occurred. The manipulation object image file name 1006 is recorded with an image of the manipulation object operated by the user 101 which was detected by the manipulation object detection unit 107. The non-manipulation object image file name 1007 is recorded with an image of a non-manipulation object not operated by the user 101 which was detected by the manipulation object detection unit 107. If there are two or more of the non-manipulation objects, a plurality of image file names may be recorded in the non-manipulation object image file name 1007. The anomaly category 1008 is recorded with an anomaly category number entered by the abnormality informing device 105. Details of the anomaly may be recorded as well as the anomaly category number. The abnormality occurrence time 1009 is recorded with a time at which an abnormality occurred during the test.

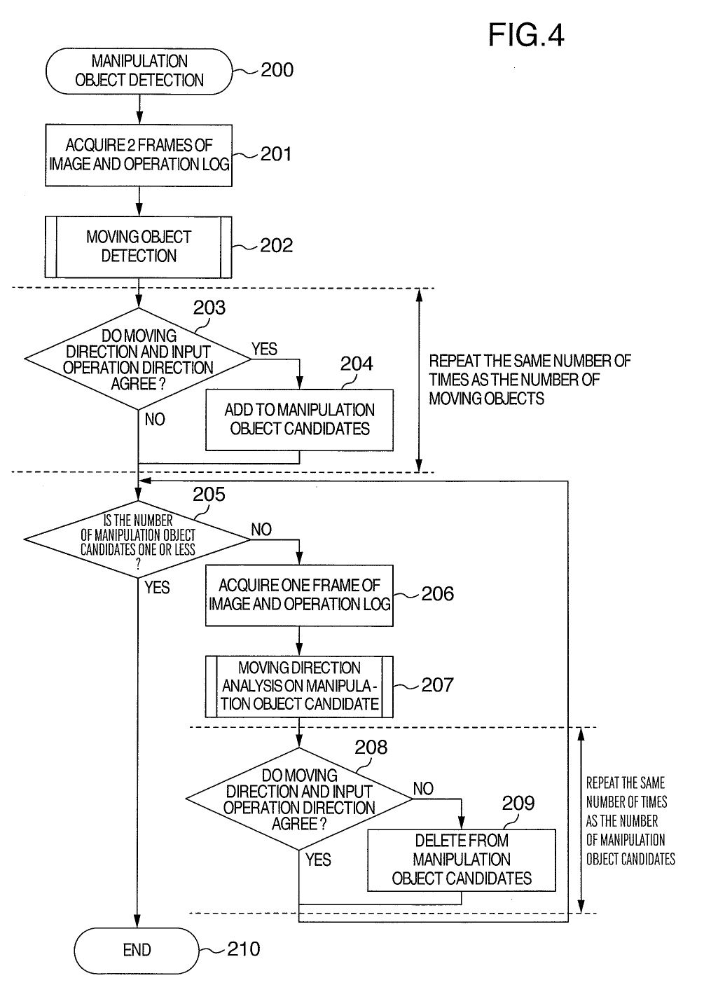

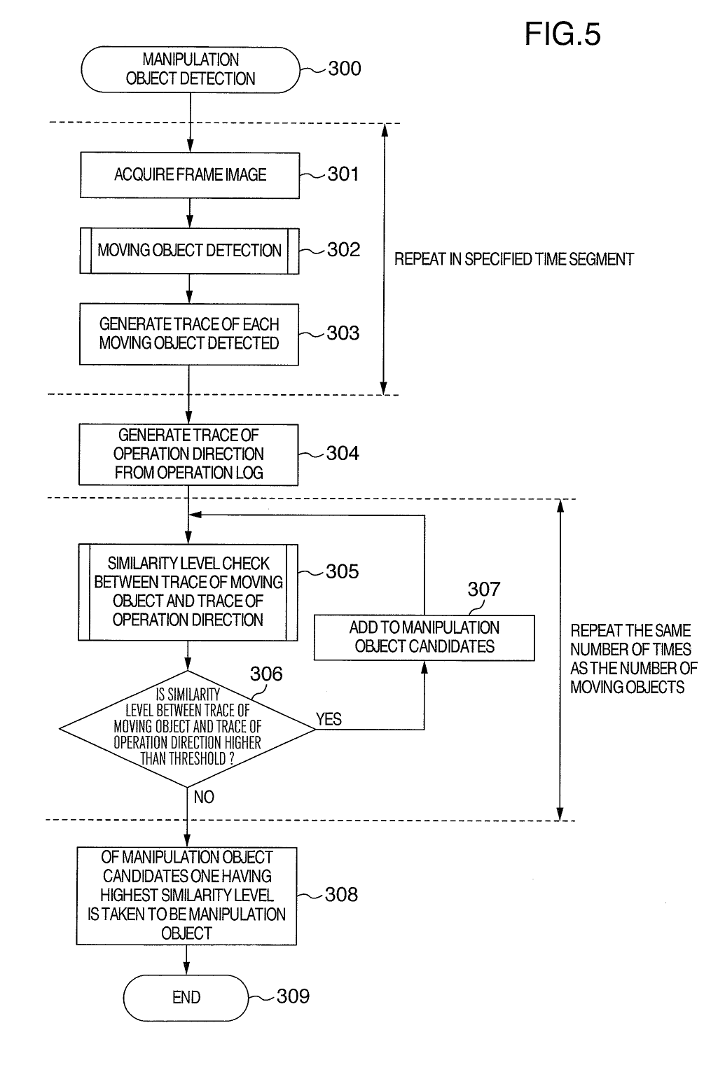

FIG. 4 is a flow chart showing an example sequence of operations executed by the manipulation object detection unit 107. The process shown in FIG. 4, which will be explained below, compares the direction of motion of the moving object and the direction of user's input operation for each frame to detect a manipulation object.

(1) When the process is started, a video and an operation log for two frames are retrieved from the output video of the video system 102 and from the input operation data from the input data conversion unit 104 (step 200, 201).

(2) Next, based on the two frames of image thus obtained, the motion detection processing is performed to detect all moving objects in the video and also determine the direction of motion of the moving objects (step 202).

(3) For all moving objects detected by step 202, a check is made of the relation between the direction of motion and the direction of input operation to see if they match. If the direction of motion of the moving object and the direction of input operation agree, the moving object is added to manipulation object candidates. This process is executed repetitively the same number of times as the number of moving objects in the video (step 203, 204).

(4) If step 203 decides that the direction of motion of the moving object and the direction of input operation do not agree, or if a check following step 204 finds that, in the processing up to the preceding step, there is only one manipulation object candidate or there is none, the manipulation object detection is ended (step 205, 210).

(5) If step 205 decides that there are two or more of the manipulation object candidates, a video and an operation log for the next one frame are retrieved from the output video of the video system 102 and from the input operation data from the input data conversion unit 104. Based on the frame image thus obtained, the image analysis is performed to determine the direction of motion of the manipulation object candidate (step 206, 207).

(6) A check is made as to whether the direction of motion of the manipulation object candidate matches the direction of the input operation. If the direction of motion of the manipulation object candidate and the direction of the input operation do not match, the moving object of interest is eliminated from the manipulation object candidates. This process is repetitively executed the same number of times as the number of manipulation object candidates in the video (step 208, 209).

(7) If step 208 decides that the direction of motion of the manipulation object candidate and the direction of the input operation agree, or after step 209 has been executed, the processing returns to step 205. This is repeated until the number of manipulation object candidates is one or less, and the manipulation object detection processing is ended (step 210).

While, in step 205, the condition for terminating the processing described above is that the number of manipulation object candidates is one or less, if it is desired to detect two or more of the manipulation object candidates, the process ending condition may be set to two or less of the manipulation object candidates.

FIG. 5 is a flow chart showing another example of operation sequence executed by the manipulation object detection unit 107 to detect manipulation objects. This process will be explained as follows. The process shown in FIG. 5 detects that a trace of a moving object continuous in time and a trace of an input operation direction continuous in time are similar, thereby detecting a manipulation object.

(1) When the processing is initiated, it first acquires from the output video of the video system 102 all frame images present in a specified time segment to generate a trace of a moving object for motion detection (step 300-302).

(2) Positions of the moving object in the specified time segment are connected together to generate a trace of the moving object. If two or more of the moving objects are detected, the trace is generated for each moving object (step 303).

(3) Next, user's input operations in the specified time segment are connected together to generate a trace of user's operation direction (step 304).

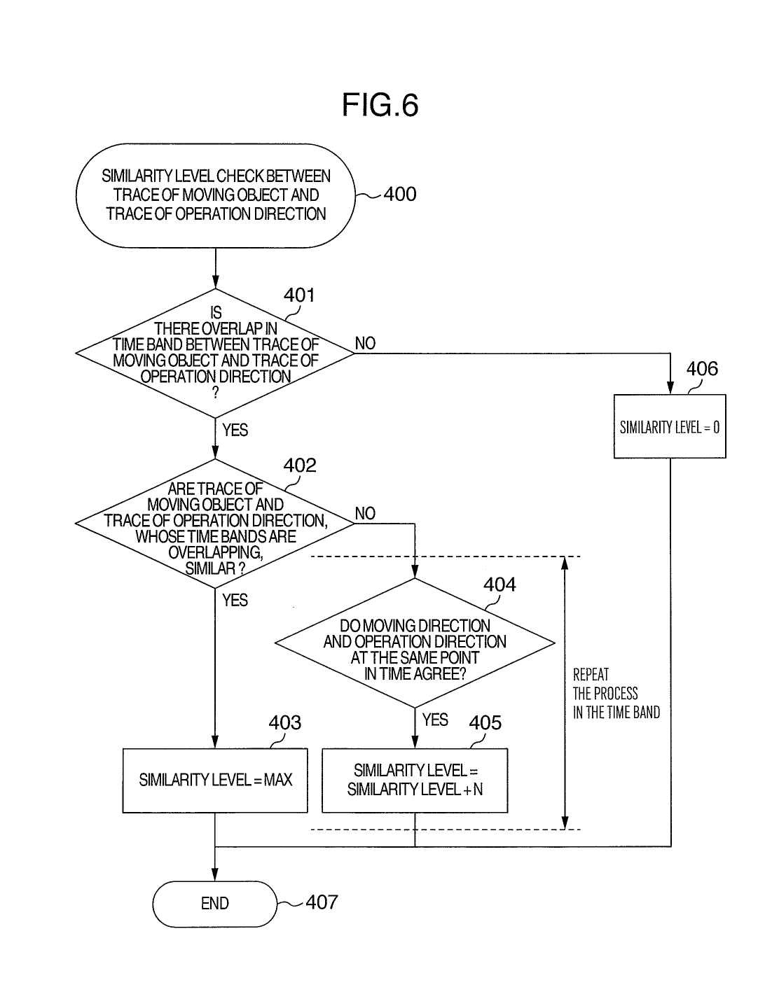

(4) Next, based on the trace of the moving object and the trace of the operation direction obtained in the preceding steps, a similarity between the trace of the moving object and the trace of the operation direction is determined. This processing will be detailed later by referring to FIG. 6 (step 305).

(5) Next, by referring to a preset threshold of similarity, a check is made to see if a level of similarity between the trace of the moving object and the trace of the operation direction is higher than the preset threshold. Those moving objects with their similarity level higher than the threshold are added to the manipulation object candidates. Then, the processing returns to step 305. This process is repeated the same number of times as the number of detected moving objects (step 306, 307).

(6) If step 305 decides that no moving objects with their similarity higher than the threshold remain, one of the manipulation object candidates with the highest similarity level is taken as a manipulation object. Now, this manipulation object detection process is exited (step 308, 309).

In the above processing, if it is desired to have two or more manipulation objects, the corresponding number of moving objects may be picked up as manipulation objects in the descending order of similarity level.

FIG. 6 is a flow chart showing a detailed sequence of operations performed in step 305 of FIG. 5 to determine a similarity level between the trace of a moving object and the trace of an operation direction. This process will be explained in the following.

(1) When the processing is started, it first checks if there is an overlap in time band between the trace of a moving object and the trace of an operation direction. If start/end times do not agree or if there is no overlap in start/end time between the trace of a moving object and the trace of an operation direction, the similarity level is set to 0, before exiting the processing (step 401, 406, 407).

(2) If step 401 decides that there is an overlap in time band between the trace of a moving object and the trace of an operation direction, a check is made to determine whether the overlapping traces are similar. If they are similar, the similarity level is set maximum, before exiting the processing (step 402, 403, 407).

(3) If step 402 decides that the overlapping traces of the moving object and of the operation direction are not similar, another check is made as to whether the direction of motion of the moving object and the operation direction at the same point in time match. If they match, a constant N is added to the similarity level (initial value=0) of the previous step of the reiterative process, thus increasing the similarity level. The processing described here is repeated in the overlapping time band to determine the similarity level and then exited. If the above check decides that the direction of motion of the moving object and the operation direction at the same point in time do not agree, the reiterative processing is executed without updating the similarity level (step 404, 405, 407).

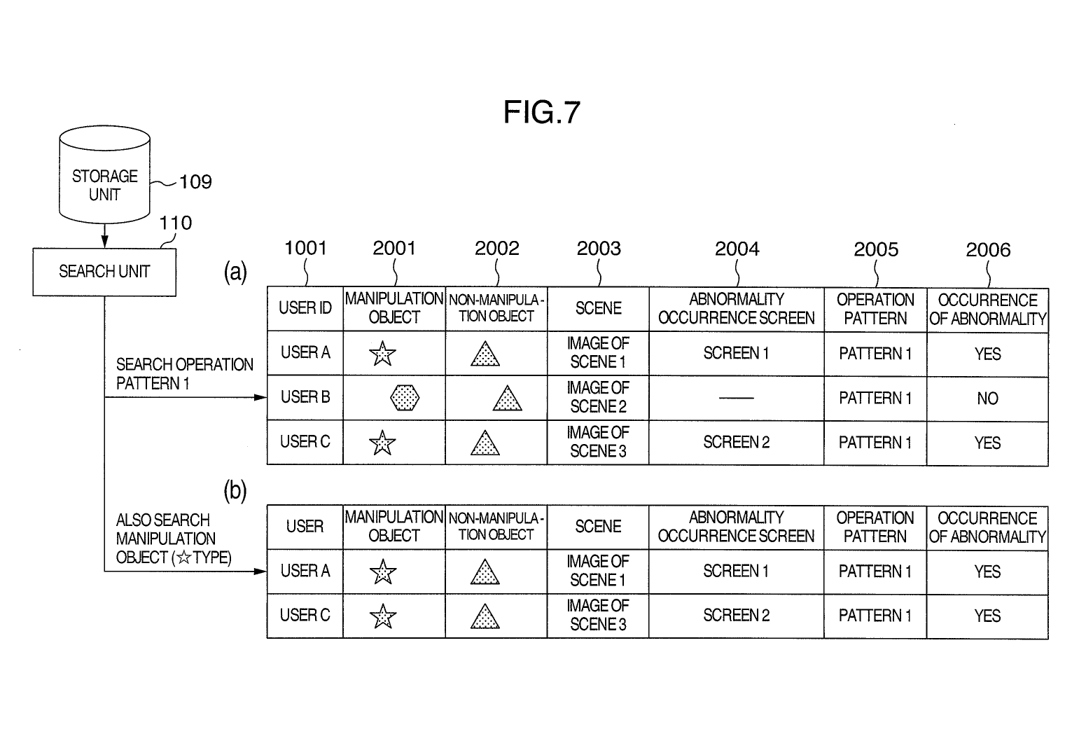

FIG. 7 shows an example result of search made by the search unit 110 for data recorded in the storage device 109 during a test. In the example shown in FIG. 7, the test data acquired are a manipulation object 2001, a non-manipulation object 2002, a scene 2003, an abnormality occurrence screen 2004, an operation pattern 2005 and an occurrence of abnormality 2006. The image data search may use an image analysis technology for similar image search. The operation pattern search may be performed by determining the similarity level from the order in which buttons are pressed or the length of time that the buttons are pressed and then picking up a pattern with the highest similarity.

The search is performed as follows. As for an abnormality that has occurred during the test by user A, for example, an assumption is made that the cause of the abnormality may be an input operation pattern 1. Based on this assumption, test results having the operation pattern 1 are searched. Then, a search result is obtained as shown in FIG. 7(a). The search result of FIG. 7(a) shows that, in the search result obtained by user B, abnormality has not occurred even though the input operation pattern 1 was executed, which means that the pattern 1 alone is not the only cause of abnormality. The comparison between the result of user B and other results leads to an assumption that a difference in manipulation object may influence the occurrence of abnormality. Then, the cause of anomaly is narrowed down by searching test results in which the manipulation object 2001 has an image of ★ type. FIG. 7(b) shows the result of search performed as described above.

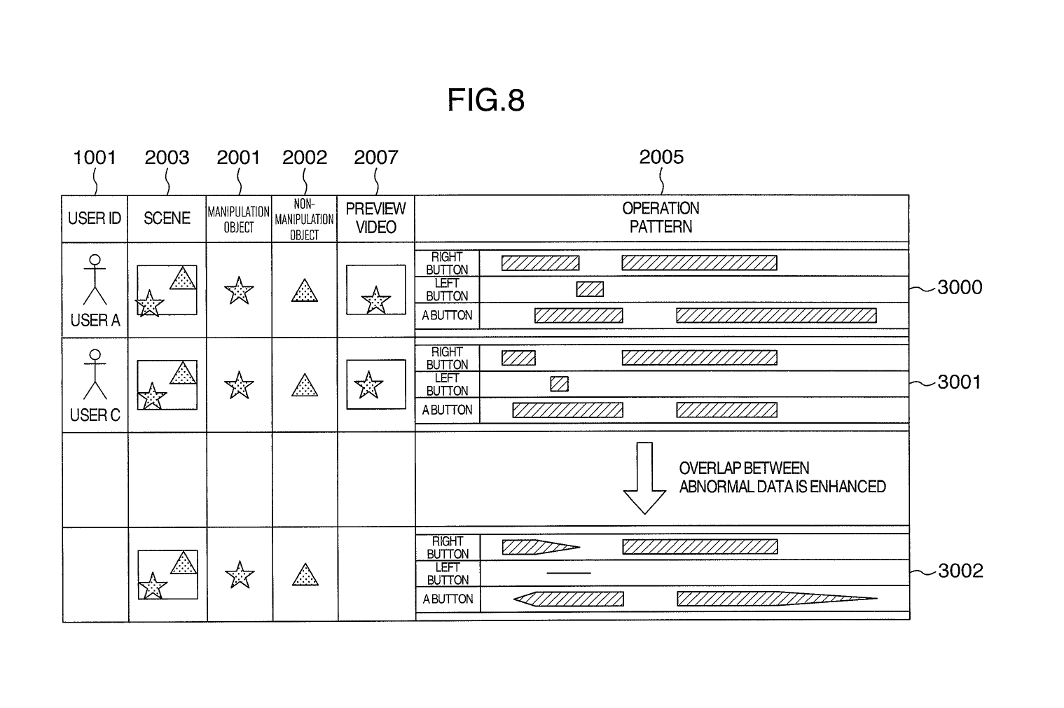

FIG. 8 shows an example monitor screen displaying the search result of FIG. 7(b). The search result of FIG. 7(b) lists a manipulation object, a non-manipulation object and an operation pattern as common factors found in the test data at time of occurrence of abnormality. These are shown at 3000, 3001 in FIG. 8.

In the example shown in FIG. 8, an operation pattern represents the pressing operation of a right button, a left button and an A button with reference to a time axis. The displayed results 3000, 3001 allow a viewer of the screen to recognize at a glance an agreement or disagreement between the manipulation object and the non-manipulation object. It is, however, difficult to compare the order or length of time in which the buttons are pressed. To deal with this problem, in addition to displaying the test data of user A and user B side by side as shown at 3000 and 3001 of FIG. 8, this embodiment also enhances or highlights the overlapping portions, with reference to the time axis, of the operation patterns by changing the thickness and color density of displayed strips, as shown at 3002. In the example of FIG. 8, the overlapping portions are enhanced or highlighted by the thickness of the displayed strips. It is also possible to display a video file corresponding to the search result as a preview video 2007 which allows an abnormally occurrence scene to be viewed.

The individual steps in the above embodiment of this invention can be built in the form of programs that can be executed by a CPU of this invention. The programs may be stored in storage media such as FD, CD-ROM and DVD for delivery. They can also be delivered as digital information via network.

As described above, the embodiment of this invention can classify moving objects into the user-manipulation objects and the non-manipulation objects based on the relation between the direction of motion of the moving object and the direction of user input operation, both acquired by the motion detection in the image analysis technology.

As for an abnormality that has occurred during a test on the video system, the embodiment of this invention collects many pieces of information, including image data of an abnormality occurrence scene obtained by the image analysis process and the manipulated and non-manipulation objects in the video as well as a video of the test and a user input operation log. Based on the collected information, the test data before and after the point of occurrence of abnormality can be searched by using the information of interest as a key. The search result is then displayed on the monitor so that a possible cause of the abnormality can be easily identified.

Presenting the generated or acquired information as described above can support the analysis of a cause of anomaly that has occurred in the video system.

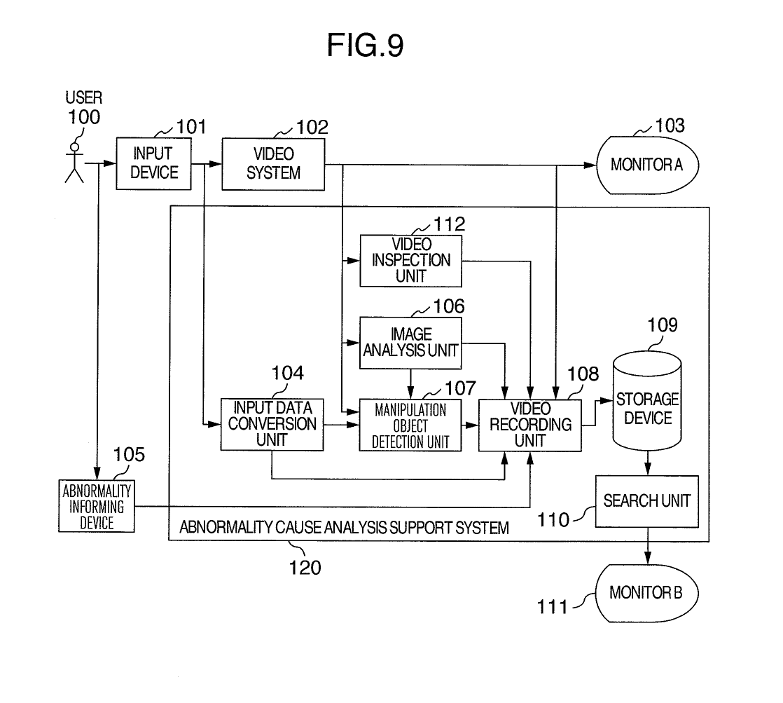

FIG. 9 is a block diagram showing a configuration of a video system abnormality cause analysis support system as still another embodiment of this invention. This embodiment differs from the preceding abnormality cause analysis support system in that it uses a video inspection unit 112 in addition to the abnormality informing device 105 to record the content of the abnormality of the video system 102.

The embodiment shown in FIG. 9 adds the video inspection unit 112, that employs the image analysis technology, in the video system abnormality cause analysis support system 120 of FIG. 1 so that, when an abnormality is found in the output video from the video system 102, the content of the abnormality is recorded in the storage device 109 through the video recording unit 108. The added video inspection unit 112 is designed to detect undesired video effects, including those considered to cause a photo-hypersensitivity fit for a person watching blinking images with sharp brightness variations and those considered to influence human subconscious, such as produced by subliminal videos. The video inspection unit 112 may also detect videos considered undesirable from an educational point of view, such as violent scenes.

With this embodiment which, as described above, has the video inspection unit 112 added to the abnormality cause analysis support system 120, not only can abnormalities of the video system 102 itself be recorded but undesired video effects contained in the output video of the video system 102 can also be recorded as abnormalities. The abnormal video effects can be displayed in an analysis screen that associates them with various information including contents of operations performed by the user 100 or manipulation object. Displaying the analysis screen that associates the abnormal video effects with various information such as contents of operations executed by the user 100 facilitates the analysis of causes for the abnormal video effects.

With this embodiment, based on the relation between the direction of motion of a moving object moving in a video output from the video system and the direction of user input operation, the moving objects in the video can be classified into the user-manipulation objects and the non-manipulation objects. This allows the user-manipulation objects and the non-manipulation objects to be added as a key for searching abnormalities that occur in the video system, facilitating more detailed classification of the video system test results. The more detailed classification of the test results of the video system helps find factors that are common to abnormalities of the similar kind or conditions in which abnormalities do not occur if there are similar factors. As a result, the analysis of the cause for abnormalities in the video system can be conducted more easily.

This invention can be applied as an abnormality cause analysis support system for computer graphics-based video systems, which include home or commercial game machines and video systems using a virtual reality technology.

Further, this invention can also be applied as an abnormality cause analysis support system for robots and robot arms which evaluates the relation between the motion of the remotely controlled robots or robot arms and the operation inputs by detecting their motion from a video.

It should be further understood by those skilled in the art that although the foregoing description has been made on embodiments of the invention, the invention is not limited thereto and various changes and modifications may be made without departing from the spirit of the invention and the scope of the appended claims.

1. A motion detection method for detecting moving objects in a video output from a video system, wherein the video system can manipulate objects included in the video, the method comprising the steps of:
detecting a motion of an object included in the video;
acquiring a content of input operations on the video system from an input device; and
from a correlation between a direction of motion of the moving object detected by the motion detection step and the content of the input operations on the video system, deciding whether the moving object detected by the motion detection step is moving according to, or irrespective of, the input operations on the video system from the input device.

2. A motion detection method for detecting moving objects in a video output from a video system, wherein the video system can manipulate objects included in the video, the method comprising the steps of:
detecting a motion of an object included in the video;
acquiring a content of input operations on the video system from an input device; and
from a correlation between a trace of the moving object obtained by connecting, with reference to time, positions of the moving object detected by the motion detection step and an input trace obtained by picking up input operations representing directions from among input operations on the video system from the input device and connecting them with reference to time, deciding whether the moving object detected by the motion detection step is moving according to, or irrespective of, the input operations to the video system from the input device.

3. An abnormality cause analysis support method for a video system, wherein the video system can manipulate objects included in the video, the abnormality cause analysis support method comprising the steps of:
detecting a motion of an object included in the video;
acquiring a content of input operations on the video system from an input device;
from a correlation between a direction of motion of the moving object detected by the motion detection step and the content of the input operations on the video system, deciding whether the moving object detected by the motion detection step is moving according to, or irrespective of, the input operations on the video system from the input device;
recording the content of input operations on the video system from the input device, output videos from the video system and inputs from an abnormality informing device that informs that some abnormality has occurred with the video system;
searching categories of inputs from the abnormality informing device, contents of input operations on the video system from the input device, output videos from the video system and recorded similar images of the moving objects; and
classifying the searched information into groups for display to support the analysis of causes for abnormalities that have occurred in the video system.

4. An abnormality cause analysis support method for a video system, wherein the video system can manipulate objects included in the video, the abnormality cause analysis support method comprising the steps of:
detecting a motion of an object included in the video;
acquiring a content of input operations on the video system from an input device;
from a correlation between a trace of the moving object obtained by connecting, with reference to time, positions of the moving object detected by the motion detection step and an input trace obtained by picking up input operations representing directions from among input operations on the video system from the input device and connecting them with reference to time, deciding whether the moving object detected by the motion detection step is moving according to, or irrespective of, the input operations on the video system from the input device;
recording the content of input operations on the video system from the input device, output videos from the video system and inputs from an abnormality informing device that informs that some abnormality has occurred with the video system;
searching categories of inputs from the abnormality informing device, contents of input operations on the video system from the input device, output videos from the video system and recorded similar images of the moving objects; and
classifying the searched information into groups for display to support the analysis of causes for abnormalities that have occurred in the video system.

5. An abnormality cause analysis support method for a video system, according to claim 3, further including the steps of:
recording abnormal images of the video itself detected by an image analysis technique from the output video from the video system;
searching also the abnormal images of the video; and
classifying the searched information into groups for display.

6. An abnormality cause analysis support system for a video system, wherein the video system can manipulate objects included in the video, the abnormality cause analysis support system comprising:
means for detecting a motion of an object included in the video;
means for acquiring a content of input operations on the video system from an input device;
means for, from a correlation between a direction of motion of the moving object detected by the motion detection means and the content of the input operations on the video system, deciding whether the moving object detected by the motion detection means is moving according to, or irrespective of, the input operations on the video system from the input device;
means for recording the content of input operations on the video system from the input device, output videos from the video system and inputs from an abnormality informing device that informs that some abnormality has occurred with the video system;
means for searching categories of inputs from the abnormality informing device, contents of input operations on the video system from the input device, output videos from the video system and recorded similar images of the moving objects; and
means for classifying the searched information into groups for display to support the analysis of causes for abnormalities that have occurred in the video system.

7. An abnormality cause analysis support system for a video system, wherein the video system can manipulate objects included in the video, the abnormality cause analysis support system comprising:
means for detecting a motion of an object included in the video;
means for acquiring a content of input operations on the video system from an input device;
means for, from a correlation between a trace of the moving object obtained by connecting, with reference to time, positions of the moving object detected by the motion detection step and an input trace obtained by picking up input operations representing directions from among input operations on the video system from the input device and connecting them with reference to time, deciding whether the moving object detected by the motion detection means is moving according to, or irrespective of, the input operations on the video system from the input device;
means for recording the content of input operations on the video system from the input device, output videos from the video system and inputs from an abnormality informing device that informs that some abnormality has occurred with the video system;
means for searching categories of inputs from the abnormality informing device, contents of input operations on the video system from the input device, output videos from the video system and recorded similar images of the moving objects; and
means for classifying the searched information into groups for display to support the analysis of causes for abnormalities that have occurred in the video system.

8. An abnormality cause analysis support system according to claim 7, further including:
means for recording abnormal images of the video itself detected by an image analysis technique from the output video from the video system;
means for searching also the abnormal images of the video; and
means for classifying the searched information into groups for display.

9. An abnormality cause analysis support method for a video system, according to claim 4, further including the steps of:
recording abnormal images of the video itself detected by an image analysis technique from the output video from the video system;
searching also the abnormal images of the video; and
classifying the searched information into groups for display.

10. An abnormality cause analysis support system according to claim 6, further including:
means for recording abnormal images of the video itself detected by an image analysis technique from the output video from the video system;
means for searching also the abnormal images of the video; and
means for classifying the searched information into groups for display.
